(19) United States
(12) Patent Application Publication
(10) Pub. No.: US 2012/0048583 A1
(43) Pub. Date: Mar. 1, 2012

(54) RECIPROCATING PNEUMATIC TOOL

(75) Inventor: CHING-SHUN CHANG, TAICHUNG CITY (TW)

(73) Assignee: SING HUA INDUSTRIAL CO., LTD., DA'AN TOWNSHIP (TW)

(21) Appl. No.: 12/869,915

(22) Filed: Aug. 27, 2010

(51) Int. Cl. B25F 5/00

(52) U.S. Cl. 173/169

(57) ABSTRACT

A reciprocating pneumatic tool has a main tool body, a suspension internal slider and a rear damping spring. A front buffer air chamber is formed the main tool body and the suspension internal slider. A by-pass air supply passage is set into the cylinder wall of the main tool body and is arranged at interval with the hollow chamber along its extension. Both ends of the by-pass air supply passage have a first and a second venting end. The first venting end is linked to the air control valve chamber of the air pressure control module, and the second venting end is linked to the front buffer air chamber. Air pressure passing through air control valve chamber can be guided the through by-pass air supply passage, so the front buffer air chamber accumulates air pressure to generate a damping effect on the front end of the suspension internal slider.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a pneumatic tool, and more particularly to an innovative one which is configured with a buffer structure.

2. Description of Related Art Including Information Disclosed Under 37 CFR 1.97 and 37 CFR 1.98.

Reciprocating pneumatic tools, such as: pneumatic saws, pneumatic hammers and pneumatic cutters, are available with different functions depending on the patterns of the tool end. In the present invention, said reciprocating pneumatic tool is also provided with such patterns.

According to the operating principle of a reciprocating pneumatic tool, pneumatic supply is guided into the tool, then controlled by a control valve for its on/off state, and activated by an actuator module for automatic guide and switching. Meanwhile a piston rod along with the tool end (e.g., saw and hammer) generates reciprocating movement.

In view of the existing strong vibration of conventional reciprocating pneumatic tool, a buffer structure has been developed to address such problems. The major concern of the present invention is focused on said buffer structure.

For the relevant buffer structure of typical reciprocating pneumatic tool, refer to Taiwan patent No. 471377: “A Suspension Damping Mechanism of Handheld Pneumatic Tool”, wherein a suspension bushing is used to assemble the actuator module into an independent unit, so the bushing can slide in the bore of the casing. A front damping spring is assembled between the bushing and the front end of the bore, while a rear damping spring is assembled between the bushing and air guide support for damping purpose. However, it is found from actual applications that, the double-spring damping mechanism is structurally designed in a manner wherein it is elastically supported by the front and rear damping springs to enable bi-directional suspension damping of the bushing. Yet, as the front and rear damping springs are in a normal compression state of different degrees, they cannot be fully released, leading to shorter service life. Moreover, both the front and rear damping springs are physical elements, friction or bigger noise may occur during instantaneous compression or release process, making it necessary to address these problems.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production and development of related products.

### BRIEF SUMMARY OF THE INVENTION

Based on the unique structural configuration of present invention wherein the “reciprocating pneumatic tool” mainly comprises a front buffer air chamber and a by-pass air supply passage, air pressure passing through air control valve chamber of the air pressure control module is fed via air guide passage to the actuator module and piston of the suspension internal slider for reciprocating movement. On the other hand, air pressure is guided through by-pass air supply passage, so the front buffer air chamber accumulates air pressure to generate a damping effect on the front end of the suspension internal slider. Thus, the reciprocating pneumatic tool of the present invention is of a rear spring-loaded and front air-pressure type buffer structure, enabling simplification of the components, extension the service life of rear damping spring and reduction of the noise level with better applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the preferred embodiment of the reciprocating pneumatic tool of the present invention.

FIG. 2 shows a sectional view of the preferred embodiment of the reciprocating pneumatic tool of the present invention.

FIG. 3 shows a schematic view of the front buffer air chamber of the present invention in an air accumulating state.

FIG. 4 shows an isolated view of the rear damping spring of the present invention.

FIG. 5 shows a schematic view of the present invention wherein the main tool body's cylinder wall is provided with a chamfering flange.

FIG. 6 shows another schematic view of the front buffer air chamber of the present invention.

FIG. 7 shows a schematic vie w of the present invention wherein the air control valve chamber's lateral wall is provided with a lateral air guide passage connecting with by-pass air supply passage.

### DETAILED DESCRIPTION OF THE INVENTION

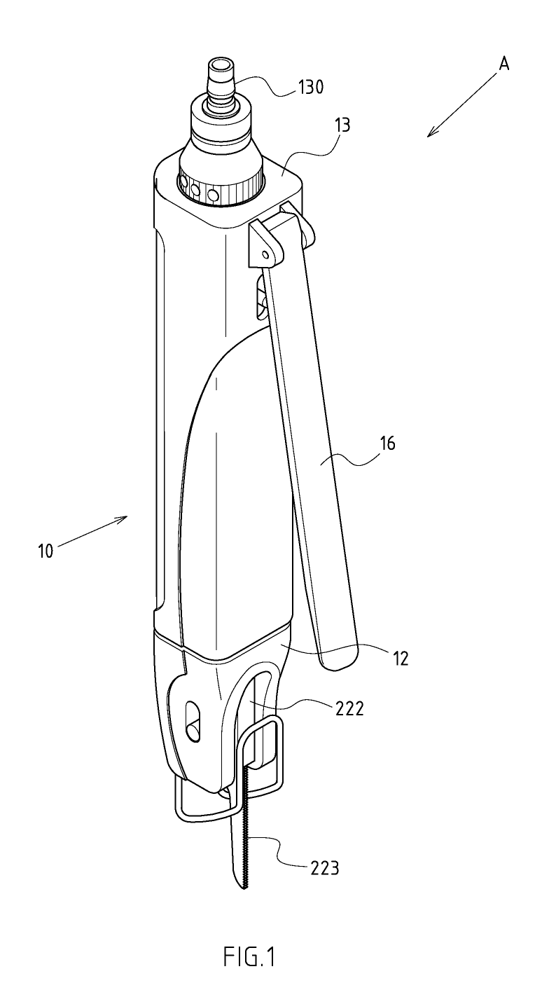

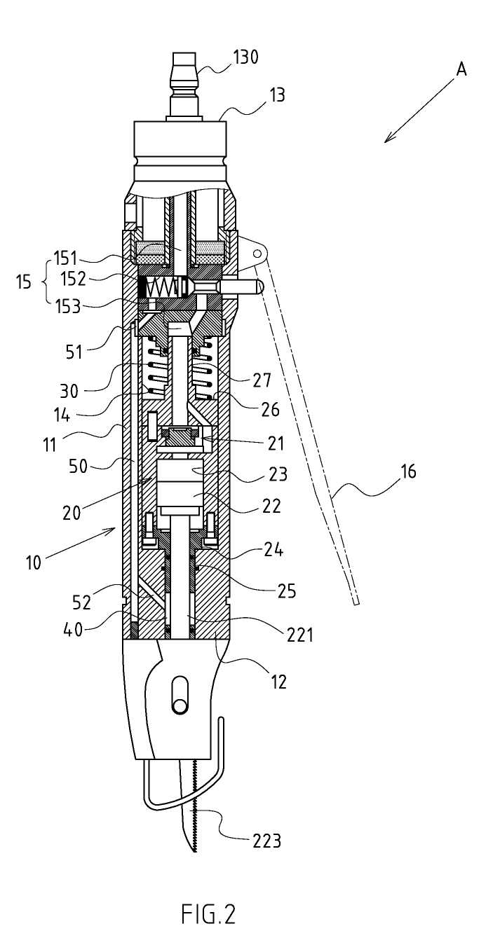

FIGS. 1-3 depict preferred embodiments of a reciprocating pneumatic tool of the present invention, which, however, are provided for only explanatory objective for patent claims. Said reciprocating pneumatic tool A includes a main tool body 10, having a cylinder wall 11, a front end 12, a rear end 13 and a hollow chamber 14. The front end 12 is provided with a through-hole 120 connecting the hollow chamber 14. The rear end 13 is fitted with an air supply connection 130, an air pressure control module 15 and a control switch 16 (a pressing handle). The air pressure control module 15 includes an air supply passage 151, an air control valve chamber 152 and an air guide passage 153. The air supply passage 151 is used to connect air supply connection 130 and air control valve chamber 152, and the air guide passage 153 is set at an inner end of air control valve chamber 152 facing the hollow chamber 14.

A suspension internal slider 20 is slidably set into the hollow chamber 14 of the main tool body 10. The suspension internal slider 20 includes an actuator module 21 and an actuating cylinder 23 with a piston 22. The front end 24 of the suspension internal slider 20 is provided with a forward flange tube 25, and the rear end 26 is provided with a backward flange tube 27. Of which, the forward flange tube 25 is penetrated into the through-hole 120 on the front end 12 of the main tool body 10, and the backward flange tube 27 is mated with air guide passage 153 of the air pressure control module 15. One end of the piston 22 is provided with an extension bar 221 that protrudes out of the forward flange tube 25. At one end of the extension bar 221, a tool joint 222 is set for assembly and locating of the tool 223 (e.g. saw).

A rear damping spring 30 is supported between the air pressure control module 15 and the rear end 26 of the suspension internal slider 20.

A front buffer air chamber 40 is formed between inner wall of the front end 12 of the main tool body 10 and the front end 24 of the suspension internal slider 20.

A by-pass air supply passage 50 is set into the cylinder wall 11 of the main tool body 10. The by-pass air supply passage 50 is arranged at interval with the hollow chamber 14 along its extension. Moreover, both ends of the by-pass air supply passage 50 are provided with a first venting end 51 and a second venting end 52, of which the first venting end 51 is linked to the air control valve chamber 152 of the air pressure control module 15, and the second venting end 52 linked to the front buffer air chamber 40.

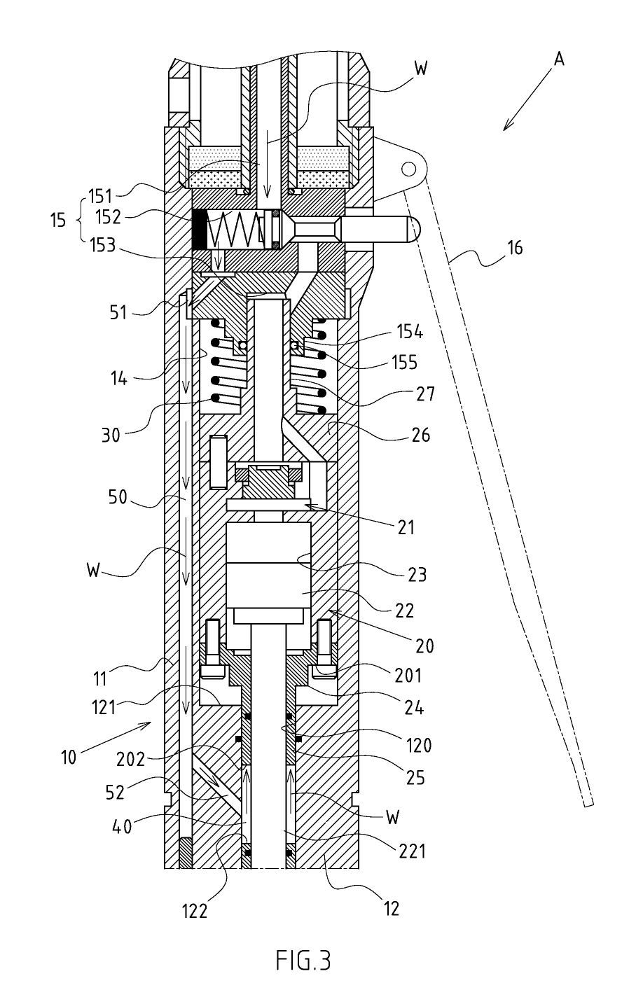

Based on above-specified structural configuration, as shown in FIG. 3, said reciprocating pneumatic tool A is operated in such a manner that, when air pressure W is charged into the air supply passage 151 of the air pressure control module 15, air pressure W passing through air control valve chamber 152 of the air pressure control module 15 is fed via air guide passage 153 to the actuator module 21 and piston 22 of the suspension internal slider 20 for reciprocating movement. On the other hand, air pressure W is guided through by-pass air supply passage 50, so the front buffer air chamber 40 accumulates air pressure to generate a damping effect on the front end 24 of the suspension internal slider 20. Thus, the reciprocating pneumatic tool A of the present invention is of a rear spring-loaded and front air-pressure type buffer structure. Moreover, when air pressure accumulated in the front buffer air chamber 40 disappears due to interruption of air supply for shutdown of reciprocating pneumatic tool A, the elastic force of the rear damping spring 30 will be in a full release state, thus extending greatly its service life.

Referring to FIG. 3, a tubular boss 154 is formed at the end of air guide passage 153 of the air pressure control module 15. A seal ring 155 is set onto inner wall of the tubular boss 154, so that the backward flange tube 27 of the suspension internal slider 20 can be slidably inserted onto the inner wall of said tubular boss 154. The rear damping spring 30 is sleeved externally onto the periphery of the tubular boss 154 and backward flange tube 27.

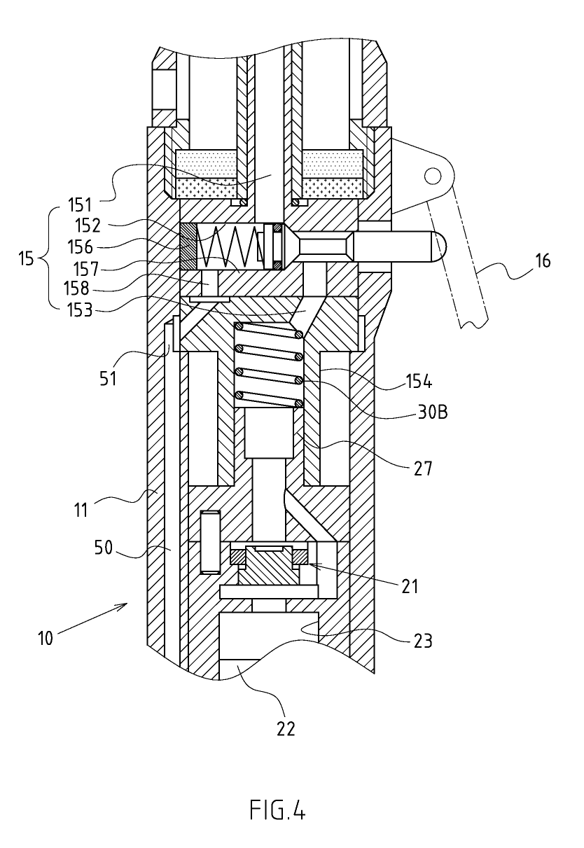

Referring also to FIG. 4, the rear damping spring 30B is sleeved between the end of the backward flange tube 27 and inner wall of the tubular boss 154 in a built-in pattern.

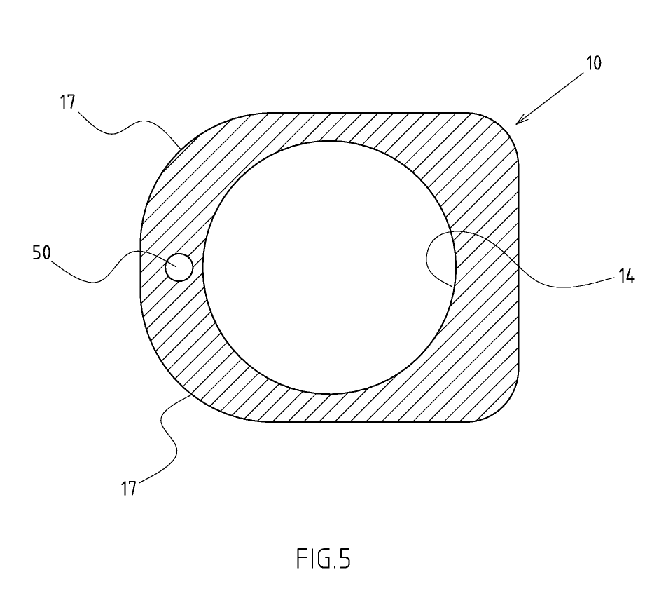

Referring also to FIG. 5, a chamfering flange 17 is formed at two corners at the side of by-pass air supply passage 50 onto the cylinder wall 11 of the main tool body 10, thus reducing the cross section of the cylinder wall 11 of the main tool body 10 for a lower material cost and higher convenience of manual operation.

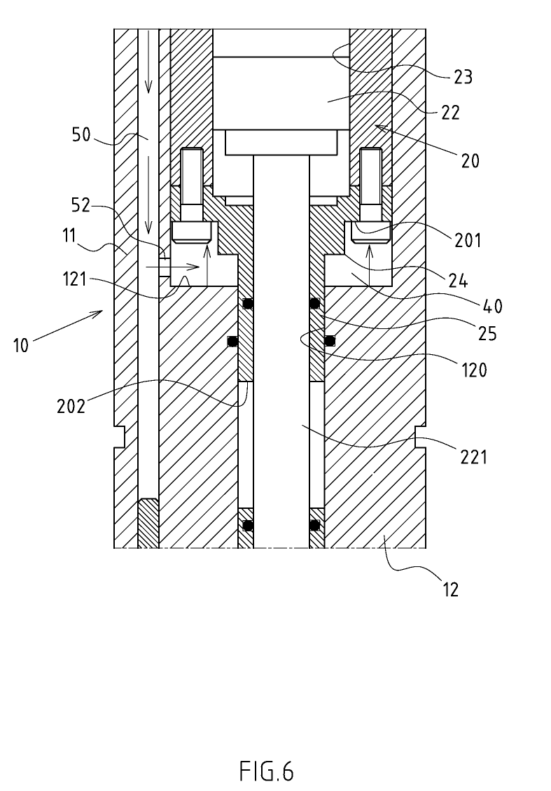

Referring to FIG. 3, an expanded wall surface 121 and a reducing wall surface 122 are formed onto the inner wall of the front end 12 of the main tool body 10 in a stepped groove pattern. An expanded end surface 201 and a flanged end surface 202 are formed correspondingly to the front end of the suspension internal slider 20; of which the expanded end surface 201 is located correspondingly to the expanded wall surface 121 of the front end 12 of the main tool body 10, and the flanged end surface 202 is located correspondingly to the reducing wall surface 122 of the front end 12 of the main tool body 10, so that said front buffer air chamber 40 is formed between the flanged end surface 202 and reducing wall surface 122. Referring also to FIG. 6, said front buffer air chamber 40 is formed between the expanded end surface 201 and expanded wall surface 121.

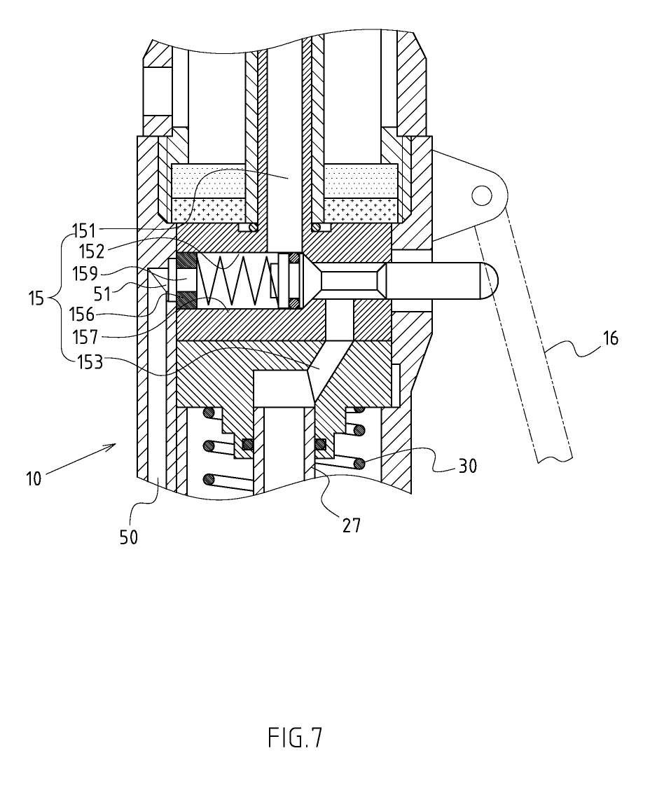

Referring to FIG. 4, the air control valve chamber 152 of air pressure control module 15 includes a lateral wall 156 and a bottom wall 157. A lower air guide passage 158 is extended downwards from the bottom wall 157 so as to connect with the first venting end 51 of the by-pass air supply passage 50. Referring also to FIG. 7, a lateral air guide passage 159 is extended laterally from the lateral wall 156 of the air control valve chamber 152 so as to connect with the first venting end 51 of the by-pass air supply passage 50.

Additionally, the detailed structure of the actuator module 21 of the suspension internal slider 20, the actuating mode of the air passage and the driving mode of the piston 22 are covered by the prior art, making it unnecessary to describe them in the present invention.

1. A reciprocating pneumatic tool, comprising:
a main tool body, comprising a cylinder wall, a front end, a rear end and a hollow chamber; the front end is provided with a through-hole connecting the hollow chamber; the rear end is fitted with an air supply connection, an air pressure control module and a control switch; the air pressure control module comprises an air supply passage, an air control valve chamber and an air guide passage; the air supply passage is used to connect air supply connection and air control valve chamber, and the air guide passage is set at inner end of air control valve chamber facing the hollow chamber;
a suspension internal slider, slidably set into the hollow chamber of the main tool body; the suspension internal slider comprises an actuator module and an actuating cylinder with a piston; the front end of the suspension internal slider is provided with a forward flange tube, and the rear end is provided with a backward flange tube; of which the forward flange tube is penetrated into the through-hole on the front end of the main tool body, and the backward flange tube is mated with air guide passage of the air pressure control module; one end of the piston is provided with an extension bar that protrudes out of the forward flange tube; a tool joint is set at one end of the extension bar;
a rear damping spring, supported between the air pressure control module and the rear end of the suspension internal slider;
a front buffer air chamber, formed between inner wall of the front end of the main tool body and the front end of the suspension internal slider;
a by-pass air supply passage, set into the cylinder wall of the main tool body; the by-pass air supply passage is arranged at interval with the hollow chamber along its extension; moreover, both ends of the by-pass air supply passage are provided with a first and a second venting end, of which the first venting end is linked to the air control valve chamber of the air pressure control module, and the second venting end linked to the front buffer air chamber;
with this configuration, air pressure passing through air control valve chamber of the air pressure control module is fed via air guide passage to the actuator module and piston of the suspension internal slider; on the other hand, air pressure is guided through by-pass air supply passage, so the front buffer air chamber accumulates air pressure to generate a damping effect on the front end of the suspension internal slider.

2. The structure defined in claim 1, wherein a tubular boss is formed at the end of air guide passage of the air pressure control module; a seal ring is set onto inner wall of the tubular boss, so that the backward flange tube of the suspension internal slider can be slidably inserted onto the inner wall of said tubular boss; the rear damping spring is sleeved externally onto the periphery of the tubular boss and backward flange tube.

3. The structure defined in claim 2, wherein the rear damping spring is sleeved between the end of the backward flange tube and inner wall of the tubular boss in a built-in pattern.

4. The structure defined in claim 1, wherein a chamfering flange is formed at two corners at the side of by-pass air supply passage onto the cylinder wall of the main tool body.

5. The structure defined in claim 1, wherein an expanded wall surface and a reducing wall surface are formed onto the inner wall of the front end of the main tool body in a stepped groove pattern; an expanded end surface and a flanged end surface are formed correspondingly to the front end of the suspension internal slider; of which the expanded end surface is located correspondingly to the expanded wall surface, and the flanged end surface is located correspondingly to the reducing wall surface, so that said front buffer air chamber is formed between the flanged end surface and reducing wall surface.

6. The structure defined in claim 5, wherein said front buffer air chamber is formed between the expanded end surface and expanded wall surface.

7. The structure defined in claim 1, wherein the air control valve chamber of air pressure control module comprises a lateral wall and a bottom wall; and, a lower air guide passage is extended downwards from the bottom wall so as to connect with the first venting end of the by-pass air supply passage.

8. The structure defined in claim 1, wherein the air control valve chamber of air pressure control module consists of comprises a lateral wall and a bottom wall; and, a lateral air guide passage is extended laterally from the lateral wall of the air control valve chamber so as to connect with the first venting end of the by-pass air supply passage.
